(19) United States
(12) Patent Application Publication
(10) Pub. No.: US 2012/0048836 A1
(43) Pub. Date: Mar. 1, 2012

(54) METHOD FOR MANUFACTURING A HOLLOW BODY OF ZINC PLATED SHEET METAL FOR AN AUTOMOBILE

(75) Inventors: Arnaud Diguet, Maurepas (FR); Jean-Christophe Saint-Martin, Versailles (FR); Henri Pinon, Courbevoie (FR)

(73) Assignee: RENAULT S.A.S., Boulogne-Billancourt (FR)

(21) Appl. No.: 13/131,623

(22) PCT Filed: Nov. 26, 2009
(86) PCT No.: PCT/FR09/52307

§ 371 Date: Nov. 16, 2011

(30) Foreign Application Priority Data
Nov. 27, 2008 (FR) 0858046

(51) Int. Cl. B23K 26/00

(52) U.S. Cl. 219/121.64

(57) ABSTRACT

The invention relates to a method for manufacturing a hollow body (10) of zinc plated sheet metal comprising at least one first sheet metal panel (12) assembled to a second sheet metal panel (14), said first panel (12) comprising a main portion (18) perpendicular to a parallel end portion (18), connected by a radius of curvature (20), said method comprising at least one laser welding step during which the first panel (12) is laser welded to the second panel (14) with a predetermined clearance (J), characterised in that the invention comprises at least one prior positioning step during which the panels (12, 14) are placed one on top of the another with no clearance, and in that during the laser welding step, the laser beam (27) is positioned in an area of the radius of curvature (20) of the first panel (12) corresponding to the predetermined clearance (J) between the first and second panels (12, 14), for “transparency” welding.

The invention relates to a method for manufacturing a hollow body of zinc plated sheet metal for an automobile.

The invention relates more particularly to a method for manufacturing a hollow body of zinc plated sheet metal for an automobile, said hollow body comprising at least a first sheet metal panel assembled with a second sheet metal panel, said first sheet metal panel comprising at least a main portion perpendicular to the second panel, an end portion parallel to the second panel and a determined radius of curvature connecting said end portion to the main portion, said method comprising at least one laser welding step during which the first panel is laser welded to the second panel while complying with a determined clearance between said first and second panels in order to allow the zinc vapors to be removed.

Numerous examples of manufacturing methods of this type are known.

Zinc plated sheet metal panels are conventionally assembled by transparency laser welding.

Fillet welding and welding in the radius, that is to say welding carried out by a laser beam positioned between the radius of curvature of the first panel and the second panel, are difficult to carry out because the large production variances of the panels obtained by drawing make it difficult to ensure satisfactory tracking of the position of the laser beam.

Transparency welding gives excellent results in terms of the strength of the assembly produced, but imposes significant constraints in the scope of welding zinc plated parts.

Specifically, during the welding, it is necessary to maintain the existence of a determined clearance of about 0.2 mm between the two panels in order to allow the zinc vapors to escape laterally from the weld bead, and thus interfere less with the capillary flow of the weld.

Also, it is particularly difficult to carry out this operation between an end portion of the first panel, parallel to the second panel, and said second panel, because the drawing tolerances are greater than the desired clearance of 0.2 mm.

The invention overcomes this drawback by assembling the end portion of the first panel and the second panel without clearance, and by performing the welding operation by transparency in the radius of curvature of the first panel, in order to carry out the welding according to the determined clearance.

To this end, the invention provides a method of the type described above, characterized in that it comprises at least one prior positioning step during which the end portion of the first panel is placed on the second panel without clearance, and in that during the laser welding step, the laser beam is positioned in a zone of the radius of curvature of the first panel corresponding to the determined clearance between the first and second panels, a laser head delivering the laser beam being arranged on one side of the two panels in order to carry out so-called “transparency” welding.

According to other characteristics of the method:
during the laser welding step, the laser head is arranged on the side of the concavity of the radius of curvature and is inclined by a determined angle at which the beam passes through the center of the radius of curvature and the normal to the radius of curvature of the first panel,
during the laser welding step, the laser beam is arranged at a determined distance from the junction between the radius of curvature of the first panel and the second panel, which is associated with carrying out the welding in a zone of the radius of curvature of the first panel corresponding to the determined clearance between the first and second panels,
the method comprises a joint tracking step simultaneous with the laser welding step, during which the position of the weld bead is measured continuously,
the method comprises a step of correcting the positioning of the laser head, during which, as a function of the position of the weld bead measured during the joint tracking step, the position of the laser head is slaved in order to adjust the determined distance so as to make it possible to carry out the welding in the zone of the radius of curvature of the first panel corresponding to the determined clearance between the first and second panels.

Other characteristics and advantages of the invention will become apparent on reading the following detailed description, in order to understand which reference will be made to the appended drawings in which:

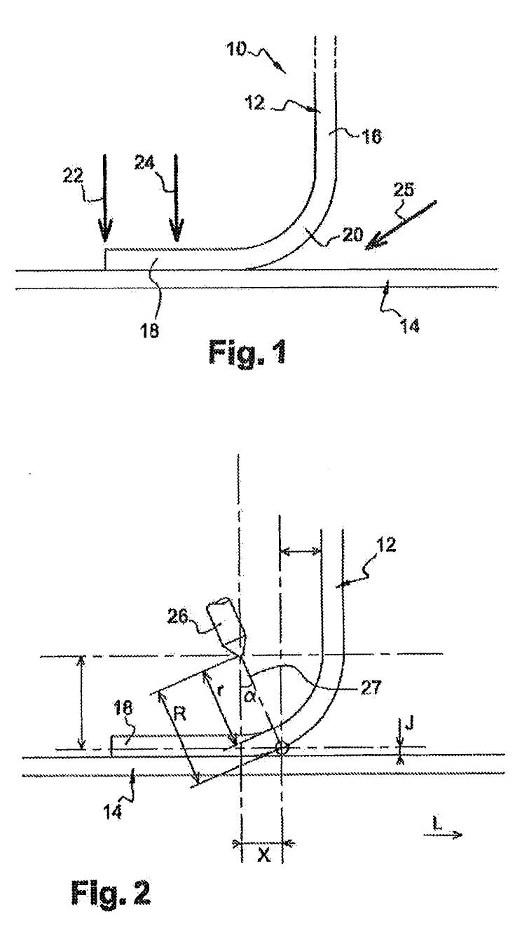

FIG. 1 is a schematic view in section of one end of a hollow body, illustrating the conventional welding methods.

FIG. 2 is a schematic view in section of one end of a hollow body, illustrating the welding method to which the invention relates.

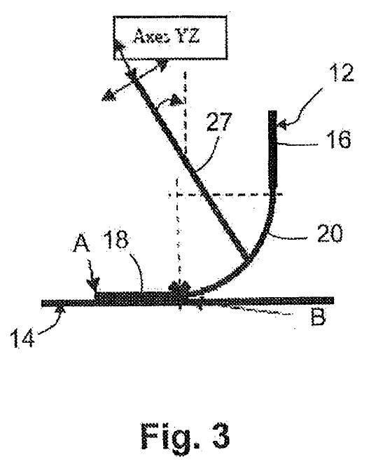

FIG. 3 is a schematic view in section of one end of a hollow body, according to FIG. 2, illustrating an example of a recalibration principle associated with the welding method to which the invention relates.

In the following description, identical references denote parts which are identical or have similar functions.

FIG. 1 represents the detail of a hollow body 10 of an automobile.

As is known, the hollow body 10 comprises at least a first sheet metal panel 12 assembled with a second sheet metal panel 14.

For example, the first sheet metal panel 12 comprises at least a main portion 16 perpendicular to the second panel 14, an end portion 18 parallel to the second panel 14 and a determined radius of curvature 20 connecting said end portion 18 to the main portion 16.

As is known, a plurality of methods may be used in order to weld the first panel 12 to the second panel 14.

The rest of the present description will address in particular the operation of welding zinc plated sheet metal panels 12, 14, which requires a determined clearance to be maintained between the panels to be welded in order to allow removal of the zinc vapors released by heating the panels, the removal of these vapors being imperative in order to prevent them from interfering with the capillary flow of the weld.

As can be seen in FIG. 1, it is firstly possible to carry out “fillet” welding in an edge zone 22 of the first panel 12. This type of welding, however, does not provide the assembly with the best rigidity.

It is also possible to carry out “transparency” welding in an intermediate zone 24 of the end portion 18 of the first panel 12, a laser head delivering the laser beam being arranged on one side of the two panels 12, 14.

In this configuration, it is necessary during the welding to maintain the existence of a determined clearance (not shown) of about 0.2 mm between the two panels 12, 14 in order to allow the zinc vapors to escape laterally from the weld bead.

It is therefore particularly difficult to carry out this operation between the intermediate portion 24 of the first panel 12 and the second panel 14, because the drawing tolerances of the two panels 12, 14 are more than the desired clearance of 0.2 mm.

Lastly, it is possible to weld in a zone 25 in proximity to the radius of curvature 20 of the first panel 12, but it is necessary to carry out precise positioning of the laser beam in order to achieve the production of a weld bead between the radius of curvature 20 of the first panel 12 and the second panel 14.

The invention proposes to take advantage of the clearances available between the radius of curvature 20 of the first panel 12 and the second panel 14 in order to carry out a transparency welding operation.

To this end, the invention provides a method for welding the panels 12, 14 described above, said method comprising at least one laser welding step during which the first panel is laser welded to the second panel while complying with a determined clearance between said first 12 and second panel 14 in order to allow the zinc vapors to be removed.

According to the invention, as represented in FIG. 2, this method comprises at least one prior positioning step during which the end portion 18 of the first panel 12 is placed on the second panel 14 without clearance. Furthermore, during the laser welding step, the laser beam 27 is positioned in a zone of the radius of curvature 20 of the first panel 12 corresponding to a determined clearance “J”, typically of the order of 0.2 mm, between the first and second panels 12, 14.

This configuration therefore makes it possible to overcome the dimensional variances resulting from the drawing of the first and second panels 12, 14, and nevertheless to ensure that the clearance “J” necessary for removing the zinc vapors is complied with.

Lastly, the method according to the invention is advantageously characterized in that a laser head 26 delivering the laser beam is arranged on one side of the two panels 12, 14 in order to carry out so-called “transparency” welding.

More particularly, the laser head 26 is preferably arranged on the side of the concavity of the radius of curvature.

This configuration has been represented in FIG. 2.

The invention is advantageous in that the position of the laser head 26 along the horizontal direction “L” determines the clearance between the radius of curvature 20 of the first panel and the second panel 14, with which the welding is carried out.

It is therefore possible, by varying the longitudinal position “X” of the laser head 26 as measured from the junction between the radius of curvature 20 of the first panel 12 and the second panel 14, to vary the clearance “J”, and vice versa, that is to say to adjust the longitudinal position “X” of the laser head 26 in order to obtain a clearance “J” corresponding ideally to a value of 0.2 mm.

A simple geometrical relationship makes it possible to calculate the theoretical position of the laser head 26.

Specifically, as illustrated in FIG. 2, in order to obtain a clearance “J” on the external radius “R” of the radius of curvature 20, starting from a position “X” of the laser head 26, we obtain the following relationships: cos α=(R−J)/R and sin α=X/R

whence: X=R sin [arccos ((R−J)/R)]

This calculation is clearly to be lowered or raised as a function of the dimensional variances obtained for the metal sheets in question.

Thus, by way of example, for a standard metal sheet with a thickness of 1.5 mm, the inner radius of curvature “r” varying between 3 mm and 6 mm, which corresponds to an external radius “R” varying between 4.5 and 6 mm, for a clearance value “J” lying between 0.17 mm and 0.23 mm, a theoretical positioning value “X” for the laser head of between 1.33 and 1.72 mm is obtained.

Another advantageous characteristic of the invention is that, preferably, the method comprises a joint tracking step simultaneous with the laser welding step, during which the position of the weld bead is measured continuously.

This measurement may also be carried out in order to read the value of the radii produced, and thereby recalculate the ideal welding positions. This measurement is preferably optical.

In this way, the method may advantageously comprise a step of correcting the positioning of the laser head 26, during which, as a function of the position of the weld bead measured during the joint tracking step, the position of the laser head 26 is slaved in order to adjust the determined distance so as to make it possible to carry out the welding in the zone of the radius of curvature 20 of the first panel 12 corresponding to the determined clearance “J” between the first and second panels 12, 14.

By way of example, the aforementioned correction step may be carried out by means of a recalibration system comprising, for example, a viewing camera, a guide table associated with the laser head and a control unit connected to the guide table and managed by various viewing algorithms.

In particular, a first example of an algorithm used may be based on the principle of tracking a plane surface. The principle of this algorithm consists in detecting the end of the plane surface, which is constructed by linear interpolation from the left or the right (parameter to be entered in the algorithm). The tracking point is then defined when the distance between the points of the part and the straight tracking line exceeds a value to be entered in the software.

Another of example of an algorithm used is based on the principle of recalibration on the basis of detecting the two edges of the metal sheet, namely detecting the portion 20 with the radius, then deducing the center.

Another example of an algorithm may be used, in the case in which the end portion 18 of the first panel 12 forms a step, as represented in FIG. 2, on the principle of taking this step into account during the recalibration. The algorithm detects the step and uses the same principle as described above, namely the principle of tracking a plane surface.

Yet another example of an algorithm used may be based on the combination of the various principles described above, namely taking into account a step at the end portion of the first panel 12 and using an edge on the other side. This last example is illustrated very schematically in FIG. 3. The algorithm therefore takes into account detection of the step at the point A in FIG. 3 and determines the calculated tracking point on the basis of the radius at the point B in FIG. 3. This recalibration therefore makes it possible to optimally adjust the position of the laser head 26, and therefore of the laser beam 27 (represented schematically by a solid line in FIG. 3), along the axes Y and Z.

The invention therefore makes it possible to assemble hollow panels of zinc plated sheet metal simply and efficiently by transparency laser welding in the radius of curvature of a panel.

1. A method for manufacturing a hollow body (10) of zinc plated sheet metal for an automobile, said hollow body comprising at least a first sheet metal panel (12) assembled with a second sheet metal panel (14), said first sheet metal panel (12) comprising at least a main portion (16) perpendicular to the second panel (14), an end portion (18) parallel to the second panel (14) and a determined radius of curvature (20) connecting said end portion (18) to the main portion (16), said method comprising at least one laser welding step during which the first panel (12) is laser welded to the second panel (14) while complying with a determined clearance (J) between said first and second panels (12, 14) in order to allow the zinc vapors to be removed,
characterized in that it comprises at least one prior positioning step during which the end portion (18) of the first panel (12) is placed on the second panel (14) without clearance, and in that during the laser welding step, the laser beam is positioned in a zone of the radius of curvature (20) of the first panel (12) corresponding to the determined clearance (J) between the first and second panels (12, 14), a laser head (26) delivering the laser beam (27) being arranged on one side of the two panels (12, 14) in order to carry out so-called “transparency” welding.

2. The manufacturing method as claimed in the preceding claim, characterized in that during the laser welding step, the laser head (26) is arranged on the side of the concavity of the radius (20) of curvature and is inclined by a determined angle (a) at which the beam passes through the center of the radius of curvature and the normal to the radius of curvature (20) of the first panel (12).

3. The manufacturing method as claimed in the preceding claim, characterized in that during the laser welding step, the laser beam (27) is arranged at a determined distance (X) from the junction between the radius of curvature (20) of the first panel (12) and the second panel (14), which is associated with carrying out the welding in a zone of the radius (20) of curvature of the first panel (12) corresponding to the determined clearance (J) between the first and second panels (12, 14).

4. The manufacturing method as claimed in the preceding claim, characterized in that it comprises a joint tracking step simultaneous with the laser welding step, during which the position of the weld bead is measured continuously.

5. The manufacturing method as claimed in the preceding claim, characterized in that it comprises a step of correcting the positioning of the laser head (26), during which, as a function of the position of the weld bead measured during the joint tracking step, the position of the laser head (26) is slaved in order to adjust the determined distance (X) so as to make it possible to carry out the welding in the zone of the radius of curvature (20) of the first panel (12) corresponding to the determined clearance between the first and second panels (12, 14).
